(19) United States
(12) Patent Application Publication
(10) Pub. No.: US 2025/0342991 A1
(43) Pub. Date: Nov. 6, 2025

(54) MAGNETIC MATERIAL

(71) Applicant: Murata Manufacturing Co., Ltd., Kyoto-fu (JP)

(72) Inventors: Mitsuru ODAHARA, Nagaokakyo-shi (JP); Yuudai NAKAE, Nagaokakyo-shi (JP); Akira OKUMURA, Nagaokakyo-shi (JP); Mikito SUGIYAMA, Nagaokakyo-shi (JP)

(73) Assignee: Murata Manufacturing Co., Ltd., Kyoto-fu (JP)

(21) Appl. No.: 19/265,387

(22) Filed: Jul. 10, 2025

Related U.S. Application Data
(63) Continuation of application No. PCT/JP2024/003688, filed on Feb. 5, 2024.

(30) Foreign Application Priority Data
Feb. 10, 2023 (JP) 2023-019452

(51) Int. Cl. H01F 1/147; H01F 27/28

(52) U.S. Cl. CPC H01F 1/147; H01F 27/28

(57) ABSTRACT

A magnetic material including a sintered body containing a metal magnetic body and a metal oxide or metal nitride produced by oxidation or nitridation of a nonmagnetic metal. The metal oxide or metal nitride is dispersed in the metal magnetic body, and the filling rate of the metal magnetic body is 81.4% or more and 99.2% or less (i.e., from 81.4% to 99.2%).

### CROSS-REFERENCE TO RELATED APPLICATIONS

This application claims benefit of priority to International Patent Application No. PCT/JP2024/003688, filed Feb. 5, 2024, and to Japanese Patent Application No. 2023-019452, filed Feb. 10, 2023, the entire contents of each are incorporated herein by reference.

### BACKGROUND

### Technical Field

The present disclosure relates to a magnetic material.

### Background Art

A composite magnetic material may be used as a magnetic material of a magnetism component. An example of the composite magnetic material includes a resin containing a soft magnetic powder, composed of powder particles, or the like in the state of being dispersed therein as described, for example, in Japanese Unexamined Patent Application Publication No. 2016-143827.

### SUMMARY

In the case of a composite magnetic material containing a resin, when a current is applied to a magnetism component including an element body, containing the magnetic material, and wiring, magnetic flux is locally concentrated between the powder particles of the soft magnetic powder in the magnetic material. Thus an eddy current loss is increased, thereby possibly leading to deterioration in high-frequency characteristics.

Accordingly, the present disclosure provides a magnetic material which can improve the high-frequency characteristics.

That is, the present disclosure provides a magnetic material including a sintered body, containing a metal magnetic body and a metal oxide or metal nitride produced by oxidation or nitridation of a nonmagnetic metal. The metal oxide or the metal nitride is dispersed in the metal magnetic body; and the filling rate of the metal magnetic body is 81.4% or more and 99.2% or less (i.e., from 81.4% to 99.2%).

The present disclosure can improve the high-frequency characteristics.

### BRIEF DESCRIPTION OF THE DRAWINGS

FIG. 1 is a photographic diagram of a magnetic material of the present disclosure;

FIG. 2 is a schematic diagram corresponding to FIG. 1;

FIG. 3 is a perspective view schematically showing an electronic component according to an embodiment containing a magnetic material of the present disclosure;

FIG. 4 is a schematic sectional view between lines a-a in FIG. 3; and

FIG. 5 is a perspective view schematically showing an electronic component according to another embodiment.

### DETAILED DESCRIPTION

A magnetic material according to an embodiment of the present disclosure is described below with referenced to the drawings. Description is made with reference to the drawings as needed, but the contents shown in the drawings are schematically and illustratively shown for understanding the present disclosure, and the appearances and dimensional ratios may be different from those of actual objects.

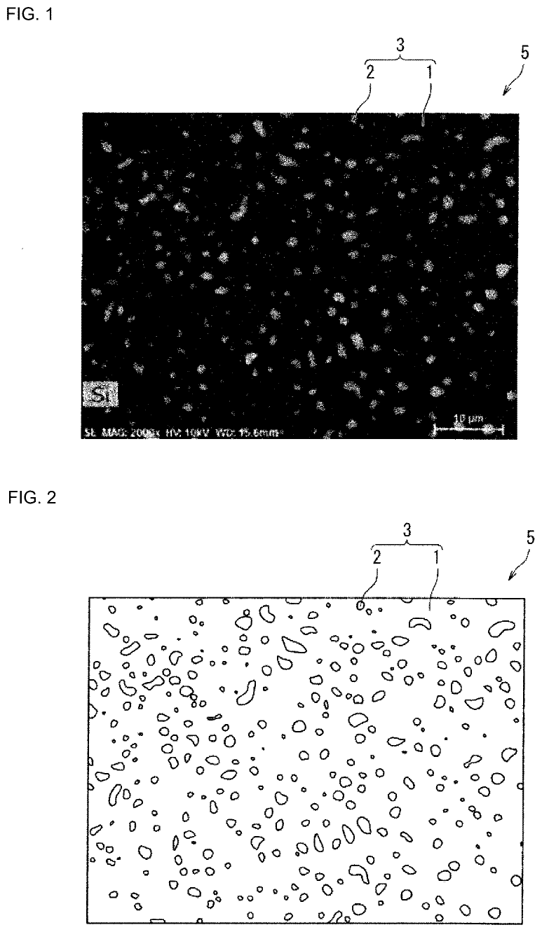

FIG. 1 is a photographic diagram of a magnetic material of the present disclosure. FIG. 2 is a schematic diagram corresponding to FIG. 1.

A previous magnetic material containing a soft magnetic powder dispersed in a resin has the possibility of leading to deterioration in high-frequency characteristics, and thus the inventors of the present disclosure earnestly investigated a new magnetic material having a configuration different from the previous magnetic material, leading to the disclosure.

Specifically, as shown in FIG. 1 and FIG. 2, a magnetic material 5 of the present disclosure includes a sintered body 3 containing a metal magnetic body 1 and a metal oxide or metal nitride 2 produced by oxidation or nitridation of a nonmagnetic metal. In the present disclosure, the metal oxide or metal nitride 2 is dispersed in the metal magnetic body 1. Further, in the present disclosure, the filling rate of the metal magnetic body 1 to the magnetic material 5 is 81.4% or more and 99.2% or less (i.e., from 81.4% to 99.2%).

The metal oxide or metal nitride 2 is produced by oxidation or nitridation of a nonmagnetic metal and thus may have a higher electrical resistivity than the metal magnetic body. For example, the electrical resistivity of the metal oxide or metal nitride 2 may be 1×10¹¹ Ω·cm or more and 1×10¹⁶ Ω·cm or less (i.e., from 1×10¹¹ Ω·cm to 1×10¹⁶ Ω·cm). Also, the electrical resistivity of the metal magnetic body may be 0.089 μΩ·m or more and 1.76 μΩ·m or less (i.e., from 0.089 μΩ·m to 1.76 μΩ·m). In addition, the metal oxide or metal nitride 2 itself may have non-magnetism.

The metal magnetic body 1 contains Fe element. The metal oxide or metal nitride 2 dispersed in the metal magnetic body 1 may be at least one selected from the group consisting of elements more easily oxidizable than Fe, such as Si, Al, Cr, Ca, Mg, Ti, Mn, V, Zr, Nb, and Ta. The area ratio of the metal oxide or metal nitride 2 to the magnetic material 5 of the present disclosure may be 0.8% or more and 17.1% or less (i.e., from 0.8% to 17.1%). The void ratio to the magnetic material 5 of the present disclosure may be 0% or more and 1.5% or less (i.e., from 0% to 1.5%).

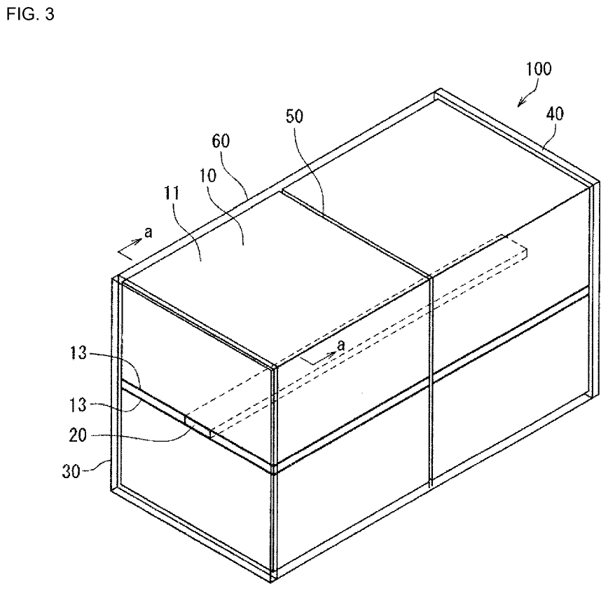

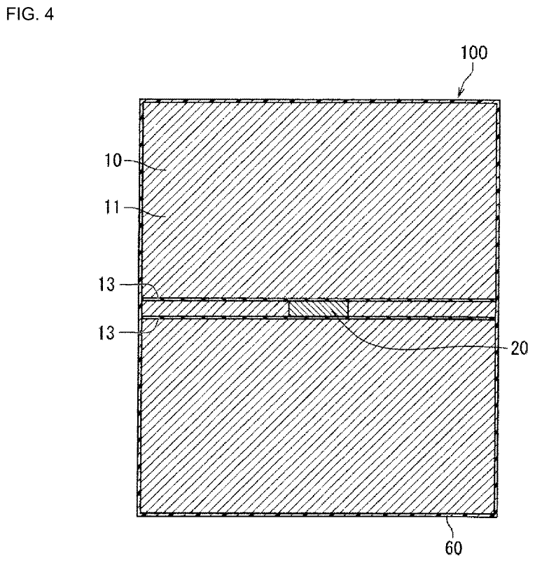

FIG. 3 is a perspective view schematically showing an electronic component containing a magnetic material of the present disclosure. FIG. 4 is a schematic sectional view between lines a-a in FIG. 3.

As shown in FIG. 3 and FIG. 4, an electronic component 100 includes an element body 10, containing the magnetic material 5 of the present disclosure, wiring 20, and outer electrodes 30 and 40. The element body 10 contains the magnetic material 5 of the present disclosure and thus contains a sintered body 11. The sintered body 11 itself has at least one metal magnetic sintered layers. As an example, the element body 10 may have a hexagonal structure. Also, an insulating coating layer 60 can be provided to coat the surface of the element body 10, excluding the outer electrodes 30 and 40.

In addition, when metal magnetic body layers having a same composition are continuously laminated in the sintered body 11, it is difficult to discriminate the boundaries between the metal magnetic body layers. Therefore, when a first insulating layer described later is not disposed between a plurality of metal magnetic layers, even a sintered body having a plurality of laminated magnetic layers is handled as one sintered body. Also, even when a plurality of metal magnetic body layers having different compositions are laminated in a sintered body and these layers can be discriminated, the sintered body is handled as one sintered body unless a first insulating layer described later is disposed between the layers.

As an example, the wiring 20 may be provided in the element body 10. The wring 20 is a conductive material which may be at least one selected from the group including, for example, silver, copper, aluminum, and the like. The form of the wiring 20 may be, for example, straight wiring as shown in FIG. 3. The wiring is not limited to this and may be coiled wiring. The outer electrodes 30 and 40 are provided on the surface of the element body 10. The outer electrodes are respectively connected to both ends of the wiring 20 and disposed to be separated from each other with the element body 10 interposed therebetween.

The element body 10 contains the magnetic material 5 of the present disclosure and thus contains the metal oxide or metal nitride having relatively high resistance. Therefore, the electric resistance of the path of the eddy current flowing through the sintered body 11 of the element body 10 can be increased, and thus the eddy current loss can be decreased. The eddy current loss is increased with increasing frequency of the current, and thus the high-frequency characteristics can be improved by decreasing the eddy current loss.

In the present disclosure, the filling rate of the metal magnetic body 1 in the magnetic material 5 is 81.4% or more and 99.2% or less (i.e., from 81.4% to 99.2%), and the filling rate of the metal magnetic body 1 in the sintered body 11 of the element body 10 may be within the same range. When the filling rate of the metal magnetic body 1 is 81.4% or more, magnetic permeability, that is, an inductance value (L value), of the electronic component 100 can be preferably secured. Also, when the filling rate of the metal magnetic body 1 is 99.2% or less, the metal oxide or metal nitride having relatively high resistance is contained in a portion (0.8% or more) other than the metal magnetic body in the magnetic material 5, excluding voids. Therefore, the decrease in eddy current loss can be attempted.

Further, in the present disclosure, the area ratio of the metal oxide or metal nitride 2 in the magnetic material 5 is 0.8% or more and 17.1% or less (i.e., from 0.8% to 17.1%), and the area ratio of the metal oxide or metal nitride 2 in the sintered body 11 of the element body 10 may be within the same range. Therefore, the overall conductivity of the sintered body 11 can be decreased, and thus the Joule loss of the metal magnetic sintered body can be decreased. Also, in the present disclosure, the void ratio in the magnetic material 5 is 0% or more and 1.5% or less (i.e., from 0% to 1.5%), and the void ratio in the sintered boy 11 of the element body 10 may be within the same range. The space factor of the metal magnetic body in the whole of the sintered body 11 can be preferably secured. Consequently, a decrease in accumulable magnetic energy can be suppressed, thereby improving DC superimposition characteristics.

As shown in FIG. 3 and FIG. 4, the element body 10 further includes a first insulating layer 13 in addition to the sintered body 11. The first insulating layer 13 can be continued in a layer form from one of the sides of the sintered body 11 to the other side in a direction crossing the lamination direction L. In this form, two or more sintered bodies 11 partitioned by the first insulating layer 13 can be provided.

In this case, the element body 11 has the two or more sintered bodies 11 and the insulating layer 13, and one of the adjacent sintered bodies 11 may be laminated on the other sintered body with the insulating layer 13 interposed therebetween. When the first insulating layer 13 is disposed, the magnetic gap function can be provided as compared with when the insulating layer 13 is not disposed. In addition, the first insulating layer 13 is preferably nonmagnetic. This can improve the DC superimposition characteristics due to a decrease in magnetic permeability of the element body 10. The first insulating layer 13 is not limited to this, and the first insulating layer 13 may be a low magnetic permeability insulating layer which is not nonmagnetic and has lower magnetic permeability than the sintered body 11. In this case, the inductance can also be improved as compared with the nonmagnetic layer.

The form is not limited to the first insulating layer, the wiring 20 coated with an insulator may be provided. In this structure, a portion of the wiring 20, excluding both ends connected to the outer electrodes 30 and 40, is directly surrounded by the insulator. Thus, the insulator can function as a magnetic gap. In addition, the insulator is preferably nonmagnetic.

Therefore, the DC superimposition characteristics can be improved by a decrease in magnetic permeability of the element body 10. The insulator is not limited to this and may be a low magnetic permeability insulator which is not nonmagnetic and has lower magnetic permeability than the sintered body 11. In this case, the inductance can also be improved as compared with the nonmagnetic insulator.

With respect to the first insulating layer 13, two or more first insulating layers may be provided to be separated from each other. In an aspect shown in FIG. 3 and FIG. 4, the element body 10 has four sintered bodies 11. In this case, the wiring 20 is disposed between the first insulating layers 13, and the element body 10 may contain three or more sintered bodies 11. When the two or more first insulating layers 13 are provided, a multilayer structure may be formed, in which the two or more sintered bodies 11 and the first insulating layers 13 are alternately laminated. The magnetic gap function is more provided by disposing the two or more first insulating layers 13, and when each of the insulating layers 13 has lower magnetic permeability than the sintered bodies 11, the DC superimposition characteristics can be more improved.

Also, when the element body 10 has the two or more sintered bodies 11 as shown in FIG. 3 and FIG. 4, the first outer electrode 30 and the second outer electrode 40 are disposed on the surfaces of the sintered bodies 11 different from each other. In a state where the outer electrodes 30 and 40 are disposed as described above, the element body 10 may further include a second insulating layer 50.

Specifically, the first outer electrode 30 and the second outer electrode 40 are respectively disposed on the surfaces of the adjacent sintered bodies 11, and the first outer electrode 30 is disposed on the surface of one of the sintered bodies 11 and the second outer electrode 40 is disposed on the surface of the other sintered body 11. In this configuration, the second insulating layer 50 may be disposed between the sintered body 11 on which the first outer electrode 30 is disposed and the sintered body 11 on which the second outer electrode 40 is disposed. The second insulating layer 50 disposed as described above can prevent a short circuit between the first outer electrode 30 and the second outer electrode 40.

As an example, the second insulating layer 50 has an arrangement form in which it is extended in a direction, for example, a vertical direction, crossing the extension direction of the first insulating layer 13 and may be a slit-shaped tangible material. In addition, the second insulating layer 50 is disposed so as not to enter and divide the wiring located in the element body 10.

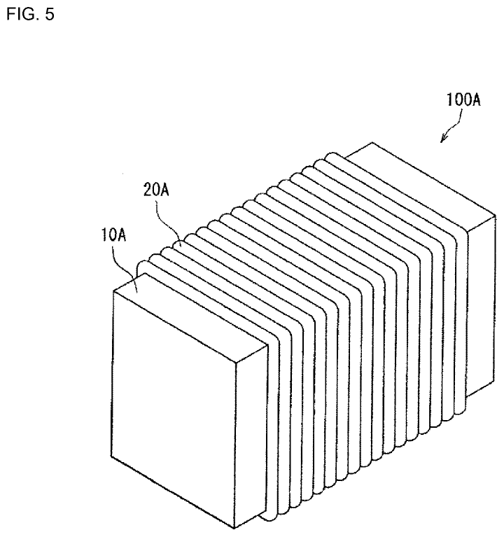

In the present disclosure, the wiring is not necessarily required to be disposed in the element body, and as shown in FIG. 5, a wiring 20A may be disposed in a state of being wound on the outside of an element body 10A.

A method for producing an electronic component containing the magnetic material of the present disclosure is described below.

### <Step of Preparing Metal Magnetic Body Particle>

First, metal magnetic body particles (for example, FeNiCo-based particles) containing a Fe component are prepared. Next, as an example, in a sol-gel method, a metal alkoxide containing nonmagnetic metal element, which is more easily oxidizable than Fe, is mixed with a solvent (for example, water, an alcohol, or the like) to produce a slurry in which the alkoxide is hydrolyzed. Then, the slurry is dried to prepare metal magnetic body particles having the surfaces coated with a coat film containing the element which is more easily oxidizable than Fe. In this case, a coat film may be further formed as a second layer on the coat film as a first layer by using a nonmagnetic metal element different from the nonmagnetic metal element used for the coat film as the first layer. The coat film may have one layer, two layers, or three or more layers.

The metal alkoxide is represented by chemical formula M (OR)ₓ (M: a nonmagnetic metal element, OR: an alkoxy group). The type of metal M constituting the metal alkoxide may be at least one selected from the group consisting of Si, Al, Cr, Ca, Mg, Ti, Mn, V, Zr, Nb, and Ta.

The metal alkoxide is not particularly limited, but is preferably an alkoxide of at least one selected from the group consisting of Si, Ti, Al, and Zr. In the present specification, Si generally called “semimetal” is handled as a metal element.

When the metal alkoxide is an alkoxide of at least one elected from the group consisting of Si, Ti, Al, and Zr, a metal oxide having higher strength and higher resistivity can be formed.

The alkoxy group OR constituting the metal alkoxide is not particularly limited and may be, for example, an alkoxy group having 10 or less carbon atoms, particularly 5 or less and more particularly 3 or less carbon atoms. The smaller the number of carbon atoms, the more easily the hydrolyzation reaction can be allowed to proceed. The alkoxy group is preferably, for example, at least one selected from the group consisting of a methoxy group, an epoxy group, and a propoxy group.

Specifically, the metal alkoxide is preferably at least one selected from the group consisting of tetraethyl orthosilicate, titanium tetraisopropoxide, zirconium-n-butoxide, and aluminum isopropoxide.

The slurry may contain a water-soluble polymer. The water-soluble polymer may be at least one selected from the group consisting of polyvinyl pyrrolidone, polyvinyl alcohol, hydroxypropyl cellulose, poly(2-methyl-2-oxazoline), polyethyleneimine, polyacrylic acid, and carboxymethyl cellulose.

The production method is not limited to the sol-gel method described above, and a coat film containing an element, which is more easily oxidizable than Fe, may be formed on the surfaces of the metal magnetic body particles. In addition, the metal magnetic body particles themselves may contain an element which is more easily oxidizable than Fe, as a composition. Further, a metal nitride component may be added to the surfaces of the metal magnetic body particles. In addition, the metal oxide and metal nitride of a nonmagnetic metal are obviously nonmagnetic.

### <Step of Preparing Metal Magnetic Body Paste>

After the metal magnetic body particles are prepared, the metal magnetic body particles are mixed with a varnish and a solvent (for example, terpineol) by a stirrer. Then, dispersion treatment is performed using a roll mill, producing a metal magnetic body paste.

### <Step of Preparing Insulator Paste>

Nonmagnetic insulator particles are prepared. Then, the insulator particles are mixed with a varnish and a solvent (for example, terpineol) etc. by a stirrer. Then, dispersion treatment is performed using a roll mill, producing an insulator paste. The nonmagnetic insulator used for the insulator paste may be, for example, a mixture of a dielectric material, such as alumina, silica, glass or calcium zirconate, strontium zirconate, and/or barium zirconate, or the like, with borosilicate glass or the like.

### <Step of Preparing Paste for Wiring>

Conductive particles are mixed with a varnish and a solvent (for example, terpineol) etc. by a stirrer. Then, dispersion treatment is performed using a roll mill, producing a paste for wiring. In addition, copper particles, silver particles, or the like may be selected as the conductive particles.

### <Step of Preparing Unfired Multilayer Body>

After each of the pastes is prepared, a metal magnetic body layer is formed in a predetermined thickness by, for example, a screen printing method using the metal magnetic body paste and then dried. After drying, a slit groove having a predetermined width is formed by laser processing, and the insulator paste is filled in the slit groove by a screen printing method or the like, and then dried. The method for forming the slit groove is not limited to post processing by laser processing, and a pattern may be previously formed by using a screen printing plate or the like.

After the insulator paste is filled in the slit groove and dried, an insulating layer is formed in a predetermined thickness on the metal magnetic body layer by a screen printing method using the insulator paste, and then dried. The type of the insulator paste used for forming the insulating layer may be different from the insulator paste filled in the slit groove.

Then, wring is formed in a desired shape (for example, a straight shape, a coil shape, a meander shape, or the like) on the insulating layer by a screen printing method using the paste for wiring. When the wiring is formed in a coil shape, a via pattern, which connects wiring patterns to each other, is formed in a plurality of metal magnetic layers by using the paste for wiring. The via pattern can be formed by previously forming holes in the metal magnetic layers by laser processing or the like and then filling the paste for wiring in the holes. After the wiring is formed, an insulating layer may be further formed on the wiring. The metal magnetic body layer is repeatedly formed, and arbitrarily the insulating layer is repeatedly formed, preparing an unfired multilayer body.

When the L value of the resultant electronic component is higher than the desired characteristic, the number of the insulating layers may be decreased or the insulating layers may be omitted. This enables the adjustment of balance between the L value and the DC superimposition characteristics. In addition, the description is made of an aspect in which the screen printing layers formed by using a screen printing method are laminated, but the method is not limited to this, and a multilayer body may be formed in an aspect in which sheets are separately prepared and then laminated.

### <Step of Individuating and Firing Unfired Multilayer Body>

The unfired multilayer body is cut into individual pieces by a dicer or the like, and then the individual pieces are degreased in a nitrogen atmosphere by using a firing furnace and then fired at a temperature of 900 degrees or more and 1000 degrees or less (i.e., from 900 degrees to 1000 degrees) in a reducing atmosphere of H₂: 3%/N₂: 97% for a predetermined time (for example, 1 hour). This enables to obtain a fired multilayer body containing the element body (sintered body) containing the magnetic material of the present disclosure and the insulating layers. In the resultant fired multilayer body, the sintered body as the element body may contain the oxide or nitride of an element, which is more easily oxidizable than Fe. In addition, the fired multilayer body may be configured so as to contain even an element, less oxidizable than Fe, after being oxidized in a separate step.

The above described is made on the assumption that the nonmagnetic insulating layer is formed, but a low magnetic permeability insulating layer may be formed, which is imparted with somewhat magnetism by extending the retention time of the maximum temperature during the firing in order to cause a metal magnetic body component to diffuse and enter from the metal magnetic body layer to the nonmagnetic insulating layer.

### <Formation of Outer Electrode>

Then, the outer surface of the sintered body is coated with an insulating resin or the like, and the coating is separated by a laser or the like from a portion where the wiring is connected to each of the outer electrodes. Then, the outer electrodes are formed by plating, thereby finally producing an electronic component. The material of the outer electrodes may be, for example, silver.

### EXAMPLES

Examples of the present disclosure are described below.

### <Acquisition of B-H Data (for Simulation)>

First, metal magnetic body particles were mixed with a varnish (resin type; ethyl cellulose, product name: Ethocel) and terpineol as a solvent by using a mortar, then the solvent was evaporated by oven-drying the resultant paste-like material, and the resultant dried material was passed through a mesh to produce a granulated powder. The granulated powder was pressure-molded by maintaining at 120 MPa for 2 minutes in a heating state at 80° C., forming each of a toroidal core and a cylindrical sample. Then, firing was performed at 900 degrees for 60 minutes in a reducing atmosphere of H₂: 3%/N₂: 97% after degreasing in a nitrogen atmosphere, producing a toroidal core and a cylindrical sample each composed of the metal magnetic sintered body.

The toroidal core was wound with a wire, and magnetic permeability μ (100 Hz) was measured by Impedance analyzer E4990A (manufactured by Keysight Inc.). The cylindrical sample was used for measuring saturation magnetic flux density Bs (16000 Oe) by vibrating sample magnetometer VSM-5 model (manufactured by Toei Industry Co., Ltd.). B-H data was calculated by putting the measured u and Bs into a formula below.

$$B = B s \times tan h ( 4 π \times 1 {0}^{- 7} \times μ \times H / Bs )$$

The Bs was calculated by using the alloy density calculated from the density of a metal material simple substance (Fe: 7.87 g/cm³, Ni: 8.9 g/cm³, Co: 8.9 g/cm³) and the composition ratio of each alloy. The calculated alloy density was as follows.

Fe10Ni20Co: 8.16 g/cm³

### <Acquisition of Conductivity (for Simulation)>

Metal magnetic body particles were mixed with a varnish (resin type; ethyl cellulose, product name: Ethocel) and terpineol as a solvent by using a mortar, then the resultant paste-like material was printed with the dimension of 30 mm×5 mm×0.2 mm on an alumina substrate using a metal mask. The printed material was degreased in a nitrogen atmosphere and then fired for 60 minutes at 900 degrees in an atmosphere of H₂: 3%/N₂: 97%, and the conductivity was calculated by measuring electric resistance using a four-terminal method.

### <Calculation of Filling Rate, Void Ratio, and High-Resistance Portion Area Ratio of Metal Magnetic Body (for Simulation)>

Each of the fired samples was hardened with a resin, ground by using grinding device Tegramin-25 (manufacture by Struers K. K.), and ion-milled by ion milling device IM-3000 (manufactured by Hitachi High-Technologies Corporation). Then, a SEM image and element mapping image were obtained by using field emission scanning electron microscope SU8230 (manufactured by Hitachi High-Technologies Corporation). The imaging magnification was 2000 times. These acquired images were analyzed by using image analysis software WinROOF 2021 (manufacture by Mitani Corporation), and the area ratio was calculated.

In the sintered toroidal coil, analysis values were obtained at any desired three positions near ½ in the thickness direction, and an average value thereof was determined. In calculating for the final electronic component, analysis values were obtained at a total of six positions, including desired three positions at a thickness of 1 time the wiring thickness on the upper side of the uppermost surface of the internal wiring and desired three positions at a thickness of 1 time the wiring thickness on the lower side of the lowermost surface of the internal wiring, and an average value thereof was determined. In addition, a method for visualizing the high-resistance portion is described later.

### <Simulation Condition and Model>

Simulation was performed by using Femtet (registered trademark) of Murata Software Co., Ltd. The software used was Femtet 2022. Magnetic field analysis (harmonic analysis) was a solver, and “calculation of inductance” was an option. The model was three-dimensional. The standard mesh size was 0.03 mm.

The B-H cave of the magnetic body was obtained by using the calculated values described above. The B-H curve was obtained by using a portion with a relative magnetic permeability μr of 1 or more so as to avoid a value equal to or lower than the vacuum magnetic permeability, and further extrapolating to the vacuum magnetic permeability using the function of Femtet 2022. Also, the calculated value described above was used as the conductivity of the magnetic body, and only the Joule loss (calculated from a current distribution) was used as the iron loss. The material of the wiring was silver.

As an electronic component model, straight wiring (length:width:thickness of 1.0 mm:0.0625 mm:0.02 mm) made of silver was formed at 0.315 mm from the lower surface at a central position in the width dimension in an element body with longitudinal dimension (L):width dimension (W)):height (T) of 1.0 mm:0.5 mm:0.629 mm. Also, a nonmagnetic insulating layer (longitudinal dimension (L):width dimension (W); height (T) of 1.0 mm:0.5 mm:0.002 mm) was formed so as to be in contact with each of the upper surface and the lower surface of the straight wiring. Further, a nonmagnetic insulating layer (width: 0.01 mm) was formed to be disposed at the central position of the longitudinal dimension (L) so as to partition into two sintered bodies between two outer electrodes.

In this case, simulation was used, but the electronic component may be produced through steps described below.

### Related to Examples 1 to 12 and Comparative Example 1

### <Step of Preparing Metal Magnetic Body Particles>

First, Fe10Ni20Co particles having a D50 particle diameter of 0.40 μm were prepared. Next, in a sol-gel method, a slurry was formed by mixing Si alkoxide and a solvent (water), and the alkoxide was hydrolyzed in the slurry. Then, the slurry was dried to produce metal magnetic body particles with the surfaces coated with a sol-gel coat film containing Si. The aimed film thickness described later was properly set by adjusting the amount of the Si alkoxide. The D50 particle diameter is not particularly limited but may be 0.40 μm or more and 3.10 μm or less (i.e., from 0.40 μm to 3.10 μm).

### <Step of Preparing Metal Magnetic Body Paste>

After the metal magnetic body particles were prepared, the metal magnetic body particles, a varnish, and terpineol as a solvent were mixed by a stirrer. Then, dispersion was performed by a roll mill, preparing a metal magnetic body paste.

### <Step of Preparing Insulator Paste>

Prepared were nonmagnetic insulator particles of alumina having a D50 particle diameter of about 0. 1 to 0.5 μm and nonmagnetic insulator particles of borosilicate glass having a D50 particle diameter of about 0. 1 to 0.5 μm. Then, these insulator particles, a varnish, and terpineol as a solvent were mixed by a stirrer. Then, dispersion was performed by a roll mill, preparing an insulator paste.

### <Step of Preparing Paste for Wiring>

Silver particles having a D50 particle diameter of about 1 to 5 μm, a varnish, and terpineol as a solvent were mixed by a stirrer. Then, dispersion was performed by a roll mill, preparing a paste for wiring.

### <Step of Preparing Unfired Multilayer Body>

After each of the pastes was prepared, a metal magnetic body layer having a predetermined thickness was formed by a screen printing method using the metal magnetic body paste described above, and then dried. After drying, a slit groove having a predetermined width was formed by laser processing, and the insulator paste was filled in the slit groove by a screen printing method or the like and then dried.

After the insulator paste was filled in the slit groove and dried, an insulating layer having a predetermined thickness was formed thereon by a screen printing method using the insulator paste and then dried.

Then, wiring was formed in a desired shape on the insulating layer by a screen printing method using the paste for wiring. An unfired multilayer body was produced by forming the metal magnetic material layer and forming the insulating layer as described above.

### <Step of Individuating and Firing Unfired Multilayer Body>

The unfired multilayer body described above was individuated by cutting with a dicer or the like, and then the resultant individual pieces were degreased in a nitrogen atmosphere using a firing furnace and then fired at 900 degrees for 1 hour in a reducing atmosphere of H₂: 3%/N₂: 97%. As a result, a fired multilayer body of a sintered body, having a high-resistance portion therein, and an insulating layer could be obtained.

### <Formation of Outer Electrode>

Then, the outer surface of the sintered body was coated with an insulating resin, and the coating on a portion where the wiring was connected to outer electrodes was separated by laser and then the outer electrodes were formed by plating. The material of the outer electrodes may be, for example, silver. Therefore, an electronic component can be obtained.

Table 1 shows the results of measurement, not simulation, of each of the items of a sintered body material actually prepared by firing the metal magnetic body paste as described above in <Step of preparing metal magnetic body paste> and <Step of individuating and firing unfired multilayer body>. Only the sintered body material was prepared without providing wiring and an insulating layer. Table 2 shows the results of simulation using the measured value date shown in Table 1.

The inductance (L) of 9 nH or more at 100 Hz and ΔL (change rate of inductance (L) at 100 kHz to the inductance (L) at 100 Hz) of −7% or more were determined as criteria for determination, and when both criteria for determination were satisfied, overall determination was A (suitable).

TABLE 1
Measurement results 1

| | Aimed | | | | Area ratio | Filling | |
|---|---|---|---|---|---|---|---|
| | film | | | | of high- | rate of | |
| | thickness | | | | resistance | metal | |
| | of SiO2 | Magnetic | | Con- | portion | magnetic | Void |
| | coat | perme- | Bs | ductivity × | (SiO2) | body | ratio |
| | (nm) | ability | (T) | 10⁶ (S/m) | (%) | (%) | (%) |
| Comparative | 0 | 70 | 2.13 | 2.08 | 0.0 | 100.0 | 0.0 |
| Example 1 | | | | | | | |
| Example 1 | 1 | 66 | 2.11 | 1.98 | 0.8 | 99.2 | 0.0 |
| Example 2 | 2 | 62 | 2.09 | 1.93 | 1.9 | 98.1 | 0.0 |
| Example 3 | 3 | 60 | 2.07 | 1.87 | 2.9 | 97.1 | 0.0 |
| Example 4 | 4 | 56 | 2.04 | 1.80 | 4.3 | 95.7 | 0.0 |
| Example 5 | 5 | 53 | 2.02 | 1.75 | 5.0 | 95.0 | 0.0 |
| Example 6 | 6 | 50 | 2.00 | 1.70 | 5.9 | 94.1 | 0.0 |
| Example 7 | 7 | 48 | 1.98 | 1.62 | 6.5 | 93.5 | 0.0 |
| Example 8 | 8 | 45 | 1.95 | 1.56 | 7.4 | 92.5 | 0.1 |
| Example 9 | 9 | 43 | 1.91 | 1.50 | 8.5 | 90.9 | 0.6 |
| Example 10 | 10 | 40 | 1.89 | 1.45 | 9.6 | 89.6 | 0.8 |
| Example 11 | 15 | 30 | 1.80 | 1.22 | 13.2 | 85.5 | 1.3 |
| Example 12 | 20 | 25 | 1.71 | 0.99 | 17.1 | 81.4 | 1.5 |

TABLE 2
Measurement results 2

| | | | | Joule loss | | Deter- | |
|---|---|---|---|---|---|---|---|
| | | | | of metal | Deter- | mination | |
| | | | | magnetic | mination | of high | |
| | | | | sintered | of L value | frequency | |
| | L at | L at | | body at | *L | characteristics | Overall |
| | 100 Hz | 100 kHz | ΔL | 100 kHz | at 100 Hz: | *ΔL: | deter- |
| | (nH) | (nH) | (%) | (W) | 9 nH or more | −7% or more | mination |
| Comparative | 16.7 | 15.4 | −7.8 | 1.0.E−05 | A | B | B |
| Example 1 | | | | | | | |
| Example 1 | 16.2 | 15.1 | −6.8 | 9.3.E−06 | A | A | A |
| Example 2 | 15.7 | 14.7 | −6.4 | 8.6.E−06 | A | A | A |
| Example 3 | 15.4 | 14.6 | −5.2 | 8.1.E−06 | A | A | A |
| Example 4 | 14.9 | 14.1 | −5.4 | 7.3.E−06 | A | A | A |
| Example 5 | 14.4 | 13.8 | −4.2 | 6.7.E−06 | A | A | A |
| Example 6 | 13.9 | 13.4 | −3.6 | 6.1.E−06 | A | A | A |
| Example 7 | 13.6 | 13.2 | −2.9 | 5.6.E−06 | A | A | A |
| Example 8 | 13.1 | 12.8 | −2.3 | 5.0.E−06 | A | A | A |
| Example 9 | 12.8 | 12.5 | −2.3 | 4.6.E−06 | A | A | A |
| Example 10 | 12.2 | 12.0 | −1.6 | 4.1.E−06 | A | A | A |
| Example 11 | 10.2 | 10.1 | −1.0 | 2.3.E−06 | A | A | A |
| Example 12 | 9.0 | 8.9 | −1.1 | 1.5.E−06 | A | A | A |

In the electronic component obtained described above, the sintered body (magnetic material) serving as the constituent element of the element body contained a metal magnetic body and a Si oxide dispersed in the metal magnetic body, and the filling rate of the metal magnetic body in the sintered body was 81.4% or more and 99.2% or less (i.e., from 81.4% to 99.2%). Regarding this point, Comparative Example 1 did not use SiO₂ and thus showed highest conductivity. Therefore, the Joule loss of the resultant metal magnetic sintered body, that is, the eddy current loss, was increased, and thus ΔL was −7.8%, and the overall determination was B

On the other hand, in Example 1 to Example 12, the Si oxide was present in a high-resistance portion dispersed in the metal magnetic body, and specifically, the area ratio of the high-resistance portion was 0.8% or more and 17.1% or less (i.e., from 0.8% to 17.1%). Therefore, the conductivity was decreased, and accordingly the Joule loss of the resultant metal magnetic sintered body was decreased. Thus, in any one of Example 1 to Example 12, ΔL was −7% or more. Also, the metal magnetic body was filled in a predetermined range in the metal magnetic sintered body, and specifically the filling rate thereof was 81.4% or more and 99.2% or less (i.e., from 81.4% to 99.2%), and thus magnetic permeability equal to or higher than a predetermined value (25 or more) was secured. As a result, the inductance (L) of 9 nH or more at 100 Hz was secured. Therefore, in any one of Example 1 to Example 12, the overall determination was A.

A method described below can be used as a method for visualizing the high-resistance portion. Specifically, each of the fired samples was hardened with a resin, and ground by using grinding device Tegramin-25 (manufactured by Struers K. K.). Then, each of the samples was processed into a shape suitable for subsequent SPM (scanning probe microscope) measurement by FIB (focused ion beam) processing, and finally cleaned by Ar flat milling.

The samples processed as described above were used for measuring spreading resistance in the SSRM (scanning spread resistance microscope) mode of SPM. In the SSRM mode, a conductive probe was scanned on the sample while a bias voltage was applied thereto, and the current flowing through each of the points was converted to a resistance value, thereby visualizing the high-resistance portion.

In this case, a potion having a resistance value of 10³ times or more of the maximum value of measured resistance values of the metal magnetic body was considered as a high-resistance value. The threshold value thereof may be properly adjusted to match with the position of a high-resistance material, such as oxide, nitride, or the like, with reference to the element mapping image.

FIG. 1 is an image with an imaging amplification of 2000 times of a visualized high-resistance portion of SiO₂ in the sintered body prepared in an example of the present disclosure. The element mapping was performed for colored portions of Si element. The other portions correspond to the metal magnetic body or void portions. In this case, in the metal magnetic body, the grain boundary phase between the metal magnetic body particles could not be recognized even by using a microscope.

This is interpreted as the result of the occurrence of particle growth of metal magnetic body particles used as a material of the metal magnetic body and sintering of the adjacent metal magnetic particles while SiO₂ is pushed aside. Aa a result, SiO₂ coated on the metal magnetic particles during the production thereof are considered to, without staying in the grain boundary phase of the metal magnetic particles, be gathered and hardened after sintering at the position in contact with three or more metal magnetic particles before making a composite. In this case, the high-resistance portions are dispersed in the sintered body, and thus the eddy current loss in the sintered body can be suppressed. Therefore, it was found that a sintered body having high magnetic permeability even at a high frequency can be formed.

The present disclosure includes aspects below but is not limited to these aspects.

<1> A magnetic material including a sintered body containing a metal magnetic body and a metal oxide or metal nitride produced by oxidation or nitridation of a nonmagnetic metal. The metal oxide or metal nitride is dispersed in the metal magnetic body; and the filling rate of the metal magnetic body is 81.4% or more and 99.2% or less (i.e., from 81.4% to 99.2%).

<2> The magnetic material described in <1>, in which the metal magnetic body contains Fe element; and the metal oxide or metal nitride is an oxide or nitride of at least one element selected from the group consisting of elements more easily oxidizable than Fe, such as Si, Al, Cr, Ca, Mg, Ti, Mn, V, Zr, Nb, and Ta.

The magnetic material described in <1> or <2>, in which the area ratio of the metal oxide or metal nitride in the magnetic material is 0.8% or more 17.1% or less (i.e., from 0.8% to 17.1%).

<4> The magnetic material described in any one of <1> to <3>, in which the void ratio is 0% or more and 1.5% or less (i.e., from 0% to 1.5%).

<5> An electronic component including an element body containing the magnetic material described in any one of <1> to <4>, and wiring.

<6> The electronic component described in <5>, which is an inductor.

An embodiment of the present disclosure is described above, but only typical examples within the application range of the present disclosure are illustrated. Therefore, it can be easily understood by a person skilled in the art that the present disclosure is not limited to these examples, and various modifications can be made.

An electronic component including the magnetic material of the present disclosure can be used as an inductor.

What is claimed is:

1. A magnetic material comprising:
a sintered body including a metal magnetic body and a metal oxide or metal nitride produced by oxidation or nitridation of a nonmagnetic metal;
wherein
the metal oxide or metal nitride is dispersed in the metal magnetic body; and
a filling rate of the metal magnetic body is from 81.4% to 99.2%.

2. The magnetic material according to claim 1, wherein
the metal magnetic body includes Fe element; and
the metal oxide or metal nitride is an oxide or nitride of at least one metal selected from the group consisting of elements more easily oxidizable than Fe, including Si, Al, Cr, Ca, Mg, Ti, Mn, V, Zr, Nb, and Ta.

3. The magnetic material according to claim 1, wherein
an area ratio of the metal oxide or metal nitride in the magnetic material is from 0.8% to 17.1%.

4. The magnetic material according to claim 1, wherein
a void ratio is from 0% to 1.5%.

5. An electronic component comprising:
an element body including the magnetic material according to claim 1, and wiring.

6. The electronic component according to claim 5, which is an inductor.

7. The magnetic material according to claim 2, wherein
an area ratio of the metal oxide or metal nitride in the magnetic material is from 0.8% to 17.1%.

8. The magnetic material according to claim 2, wherein
a void ratio is from 0% to 1.5%.

9. The magnetic material according to claim 3, wherein
a void ratio is from 0% to 1.5%.

10. The magnetic material according to claim 7, wherein
a void ratio is from 0% to 1.5%.

11. An electronic component comprising:
an element body including the magnetic material according to claim 2, and wiring.

12. An electronic component comprising:
an element body including the magnetic material according to claim 3, and wiring.

13. An electronic component comprising:
an element body including the magnetic material according to claim 4, and wiring.

14. An electronic component comprising:
an element body including the magnetic material according to claim 7, and wiring.

15. An electronic component comprising:
an element body including the magnetic material according to claim 8, and wiring.

16. An electronic component comprising:
an element body including the magnetic material according to claim 9, and wiring.

17. An electronic component comprising:
an element body including the magnetic material according to claim 10, and wiring.

18. The electronic component according to claim 11, which is an inductor.

19. The electronic component according to claim 12, which is an inductor.

20. The electronic component according to claim 13, which is an inductor.
